(19) United States
(12) Patent Application Publication
(10) Pub. No.: US 2026/0135700 A1
(43) Pub. Date: May 14, 2026

(54) ELECTRONIC DEVICE, ELECTRONIC SYSTEM INCLUDING SAME, AND OPERATING METHOD OF ELECTRONIC DEVICE

(71) Applicant: Samsung Electronics Co., Ltd., Suwon-si (KR)

(72) Inventor: Sohyun PARK, Suwon-si (KR)

(21) Appl. No.: 19/207,892

(22) Filed: May 14, 2025

(30) Foreign Application Priority Data
Nov. 13, 2024 (KR) 10-2024-0161341

(51) Int. Cl. H04L 9/08; H04L 9/32

(52) U.S. Cl. CPC H04L 9/0869; H04L 9/088; H04L 9/0894; H04L 9/3247

(57) ABSTRACT

An electronic device includes a secure memory configured to store a secret key issued by a root device, and a processor configured to generate a first temporary secret key associated with a first temporary public key based on the first temporary public key and the secret key. The first temporary public key comprises a first identifier for the root device, a second identifier for the electronic device and a first random number.

### CROSS-REFERENCE TO RELATED APPLICATIONS

This application claims the benefit of Korean Patent Application No. 10-2024-0161341, filed on Nov. 13, 2024, in the Korean Intellectual Property Office, the disclosure of which is incorporated herein by reference in its entirety.

### BACKGROUND

### 1. Field of the Invention

Example embodiments relate to an electronic device, an electronic system including the same and an operating method of the electronic device.

### 2. Description of the Related Art

Attestation technology is used to ensure the integrity of information. For example, an electronic device generates information, signs the information using an attestation key and then transmit the information to a verification device. The verification device can verify the signature to ensure that the information has not been tampered with. However, there can be security issues, for example such that when the attestation key is stolen or exposed by an attacker, the attacker can forge the information, by creating forged information and signing the forged information.

### SUMMARY

An aspect provides an electronic device by which the security is improved, an electronic system including the same and an operating method of the electronic device.

The technical tasks to be achieved by the present example embodiments are not limited to the technical tasks described above, and other technical tasks may be inferred from the following example embodiments.

According to an aspect, an electronic device includes a secure memory configured to store a secret key issued by a root device, and a processor configured to generate a first temporary secret key associated with a first temporary public key based on the first temporary public key and the secret key, wherein the first temporary public key may include a first identifier for the root device, a second identifier for the electronic device and a first random number, and based on the secret key.

According to another aspect, an operating method of an electronic device includes storing a secret key issued by a root device in a secure memory of the electronic device, and generating a first temporary secret key associated with a first temporary public key based on the first temporary public key and the secret key, wherein the first temporary public key may include a first identifier for the root device, a second identifier for the electronic device and a first random number.

According to another aspect, an electronic system includes an electronic device configured to store a secret key issued by a root device, generate a first temporary secret key associated with a first temporary public key based on the first temporary public key including a first identifier for the root device, a second identifier for the electronic device and a first random number, and based on the secret key, generate a second temporary secret key associated with a second temporary public key based on the second temporary public key including the first identifier, the second identifier, the first random number and a second random number received from a verification device, and based on the first temporary secret key, and generate a signature for a message based on the second temporary secret key, and a verification device configured to verify the signature based on the second temporary public key when the message and the signature are received from the electronic device.

Additional aspects of example embodiments will be set forth in part in the description which follows and, in part, will be apparent from the description, or may be learned by practice of the disclosure.

According to example embodiments, it is possible to provide an electronic device by which security is improved, an electronic system including the same and an operating method of the electronic device.

According to example embodiments, it is possible to prevent falsification of information even if a previously used secret key is stolen or exposed.

According to example embodiments, it is possible to pass verification only when a key based on a random number generated by a verification device is used when the verification is performed.

According to example embodiments, it is possible to generate a trusted secret key since access to the secret key is possible only when the secure booting is performed normally.

According to example embodiments, it is possible for an electronic device to generate its own trusted secret key.

According to example embodiments, it is possible to simplify the attestation process by using a public key that replaces an authentication certificate and increase attestation efficiency.

Effects of the present disclosure are not limited to those described above, and other effects may be made apparent to those skilled in the art from the following description.

### BRIEF DESCRIPTION OF THE FIGURES

These and/or other aspects, features, and advantages of the invention will become apparent and more readily appreciated from the following description of example embodiments, taken in conjunction with the accompanying drawings of which:

FIG. 1 is a drawing for explaining an electronic device and an electronic system according to an example embodiment;

FIG. 2 is a drawing for explaining the operation method of an electronic device according to an example embodiment;

FIG. 3 is a flowchart for explaining operations of an electronic device according to an example embodiment;

FIG. 4 is a flowchart for explaining operations of an electronic device according to an example embodiment;

FIG. 5 is a diagram explaining key pairs of a hierarchical structure according to an example embodiment;

FIG. 6 is a block diagram illustrating an electronic device according to an example embodiment;

FIG. 7 is a flowchart for explaining operations of booting an electronic device according to an example embodiment;

FIG. 8 is a drawing for explaining a system for signature generation according to an example embodiment; and

FIG. 9 is a diagram illustrating a system for signature verification according to an example embodiment.

### DETAILED DESCRIPTION

Terms used in the example embodiments are selected from currently widely used general terms when possible while considering the functions in the present disclosure. However, the terms may vary depending on the intention or precedent of a person skilled in the art, the emergence of new technology, and the like. Further, in certain cases, there are also terms arbitrarily selected by the applicant, and in the cases, the meaning will be described in detail in the corresponding descriptions. Therefore, the terms used in the present disclosure should be defined based on the meaning of the terms and the contents of the present disclosure, rather than the simple names of the terms.

Throughout the specification, when a component is described as “including” or “comprising” a particular element or group of elements, it is to be understood that the component is formed of only the element or the group of elements, or the element or group of elements may be combined with additional elements to form the component, unless the context indicates otherwise. The term “consisting of,” on the other hand, indicates that a component is formed only of the element(s) listed. Furthermore, items described as “ . . . unit,” “ . . . group,” and “ . . . module” described in connection with various embodiments in the specification are configured to perform at least one function or operation, and may be implemented as hardware, software, or a combination thereof.

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

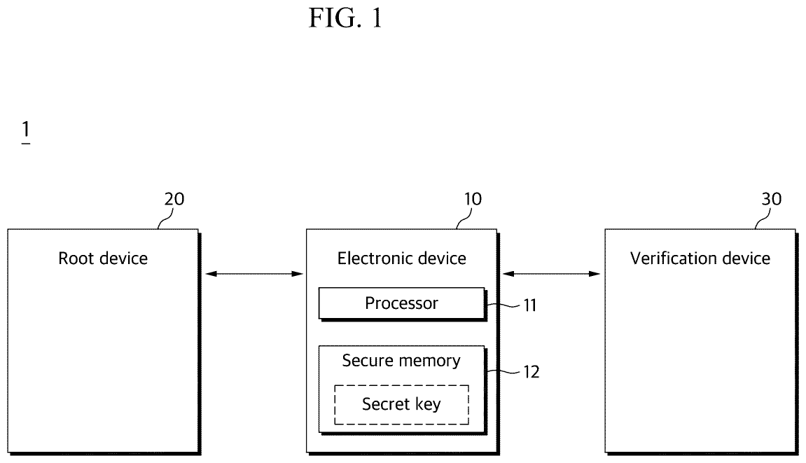

FIG. 1 is a drawing for explaining an electronic device and an electronic system according to an example embodiment.

Referring to FIG. 1, an electronic system 1 according to an example embodiment may include at least one of an electronic device 10, a root device 20, and a verification device 30. In an example embodiment, each of the electronic device 10, the root device 20 and the verification device 30 may be one of a computer, a mobile phone, a smart phone, an MP3 player, a laptop computer, a desktop computer, a server, a game console, a TV, a tablet PC and an in-vehicle infotainment system. In an example embodiment, the electronic device 10 may be one of a solid state drive (SSD), universal flash storage (UFS), an embedded multimedia card (eMMC) and secure digital (SD) card. However, it is an example embodiment, and each of the electronic device 10, the root device 20 and the verification device 30 may be implemented in variations of different types of devices. Meanwhile, the electronic device 10, the root device 20 and the verification device 30 may perform communication in various ways.

The root device 20 may represent a trusted entity within a hierarchical identity-based encryption (HIBE) system. For example, the root device 20 may be a private key generator PKG of the manufacturer that manufactured the electronic device 10.

The root device 20 may issue a secret key according to the hierarchical structure. In an example embodiment, the root device 20 may store and manage a root public key including a first identifier for the root device 20 and a root secret key associated with the root public key. In the embodiments, the secret key and the root secret key may be referred to as the private key and the root private key, respectively.

The root public key and the root secret key associated with each other may indicate a public key and a secret key used at the highest hierarchy with root authority. The public key and the secret key associated with each other may be a key pair that is used in asymmetric encryption, and may have a mathematically related relationship. The public key is a key known to everyone and is used to encrypt data or verify a signature. The secret key is a key that is associated with the public key and is not made public, and may be used to decrypt data or generate a signature.

In example embodiments, the root device 20 may issue a secret key for each electronic device based on the root secret key and the public key of the hierarchy structure. For example, the root device 20 may generate a public key that includes a first identifier for the root device 20 and a second identifier for the electronic device 10 and a secret key for the electronic device 10 based on the root secret key, and may transmit the public key and the secret key to the electronic device 10. For example, the secret key for the electronic device 10 may be a key associated with a public key that includes a first identifier and a second identifier. The public key may be a lower-hierarchy key to the root public key, and the secret key may be a lower-hierarchy key relative to the root secret key. A higher hierarchy may indicate higher authority than a lower hierarchy. For example, a lower-hierarchy secret key may be generated using a higher-hierarchy secret key.

According to an example embodiment, the electronic device 10 may store a secret key. In an example embodiment, the secret key may be generated by the root device 20 based on the root secret key and the public key. The root secret key may be a secret key associated with the root public key. The root public key may include a first identifier. The public key may include a first identifier and a second identifier. The secret key may be a key associated with the public key. For example, the public key and the secret key may be keys of a lower hierarchy than the root public key and root secret key.

Based on a first temporary public key and a secret key, the electronic device 10 may generate a first temporary secret key associated with the first temporary public key. Based on a second temporary public key and the first temporary secret key, the electronic device 10 may generate a second temporary secret key associated with the second temporary public key. Based on the second temporary secret key, the electronic device 10 may generate a signature for a message. In some embodiments, the first temporary secret key and the second temporary secret key may be referred to as the first temporary private key and the second temporary private key, respectively.

The secret key may be issued by the root device 20. The first temporary public key may include a first identifier for the root device 20, a second identifier for the electronic device 10 and a first random number. The first temporary secret key may be a secret key associated with the first temporary public key. The second temporary public key may include a first identifier, a second identifier, a first random number and a second random number. The second temporary secret key may be a secret key associated with the second temporary public key. In an example embodiment, the message may include status information of the electronic device 10.

The first identifier for the root device 20 may be manufacturer information or another unique value. For example, the first identifier may be the manufacturer name (for example, Samsung Electronics) or the model name. The second identifier for the electronic device 10 may be an eigen value representing the electronic device 10 or a user of the electronic device 10. For example, the second identifier may be the serial number of the electronic device 10 or an e-mail address of the user. However, the first identifier and the second identifier are not limited thereto and may be implemented in various example embodiments. The first random number is a random value, and may be generated by the electronic device 10. The second random number is a random value, and may be generated by the verification device 30.

In an example embodiment, the electronic device 10 may include a processor 11 and a secure memory 12.

The secure memory 12 may store a secret key issued by the root device 20. The secret key in the secure memory 12 may be a key associated with a public key including the first identifier and the second identifier. The public key and the secret key may be higher-hierarchy keys relative to the first temporary public key and first temporary secret key. The secure memory 12 may block access to the secret key when a read lock is set. The secure memory 12 may allow access to the secret key when the read lock is released. The read lock may be implemented in hardware or software.

Based on the first identifier for the root device 20, the second identifier for the electronic device 10 and the first temporary public key including the first random number and secret key, the processor 11 may generate a first temporary secret key associated with the first temporary public key. In an example embodiment, the processor 11 may generate a first temporary secret key using the first temporary public key and secret key according to various secret key generation algorithms. For example, the secret key generation algorithm may include at least one of various algorithms such as Boneh-Boyen HIBE algorithm, Gentry-Silverberg HIBE algorithm, Lewko-Waters HIBE algorithm and key derivation function (KDF). For example, the first temporary secret key of the lower hierarchy may be the result of computing a function on input parameters including the first temporary public key of the lower hierarchy and the secret key of the higher hierarchy.

According to an example embodiment, the first temporary public key may indicate a public key that is used temporarily while the value of the first random number is maintained. When the value of the first random number changes, the first temporary public key including it may also change. The first temporary secret key is associated with the first temporary public key, and may be a secret key used temporarily while the value of the first random number is maintained.

In an example embodiment, the processor 11 may generate a second temporary secret key associated with the second temporary public key based on the second temporary public key and the first temporary secret key. The second temporary public key may include a first identifier, a second identifier, a first random number and a second random number. The second random number may be generated by the verification device 30. In an example embodiment, the processor 11 may generate a second temporary secret key using the second temporary public key and the first temporary secret key according to various secret key generation algorithms.

In an example embodiment, the processor 11 may generate a signature for the message based on the second temporary secret key. For example, the processor 11 may generate a signature for a message using a second temporary secret key according to various signature/verification algorithms. The processor 11 may transmit the message and the signature to the verification device 30. The verification device 30 may receive the message and the signature from the electronic device 10.

The verification device 30 may verify the signature based on the second temporary public key. For example, the verification device 30 may verify the signature using the second temporary public key according to various signature/verification algorithms. For example, the signature/verification algorithms may include at least one of various types such as Rivest-Shamir-Adleman (RSA) algorithm, digital signature algorithm (DSA), elliptic curve digital signature algorithm (ECDSA) and Schnorr signature algorithm.

According to example embodiments, an electronic device 10 by which security is improved is provided, in addition to the electronic system 1 including the same, and an operating method of the electronic device 10. The electronic device 10 may generate its own trusted secret key using the secret key issued by the root device 20.

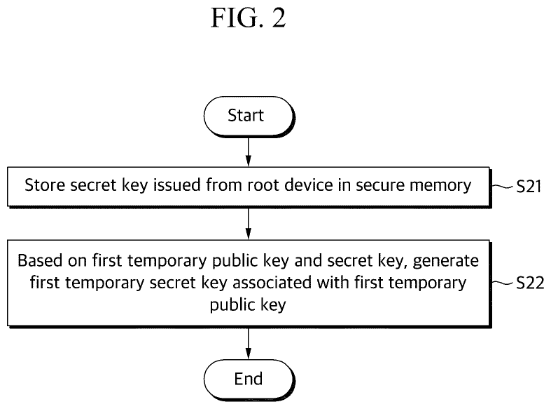

FIG. 2 is a drawing for explaining the operation method of an electronic device according to an example embodiment.

Referring to FIG. 2, the operating method of the electronic device 10 according to an example embodiment may include operation S21 which is storing a secret key issued by the root device 20 in the secure memory 12 of the electronic device 10, and operation S22 which is generating a first temporary secret key associated with the first temporary public key based on the first temporary public key and the secret key.

The secret key is a key associated with the public key. The public key may include a first identifier for the root device 20 and a second identifier for the electronic device 10. In an example embodiment, the secret key may be generated in the root device 20 and injected into the secure memory 12 of the electronic device 10. In an example embodiment, the secret key may be injected into the electronic device 10 during the manufacturing stage of the electronic device 10.

The first temporary public key may include a first identifier for the root device 20, a second identifier for the electronic device 10 and a first random number. In an example embodiment, the first random number may be generated when the electronic device 10 performs booting. For example, the first random number may change to a different value each time the electronic device 10 boots.

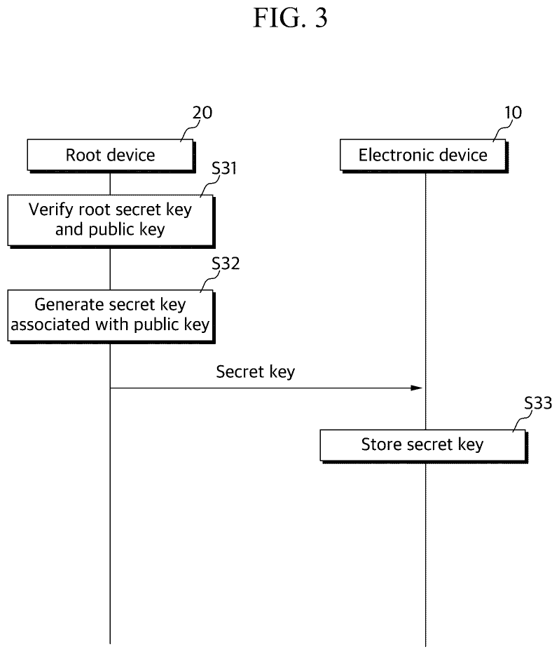

FIG. 3 is a flowchart for explaining operations of an electronic device according to an example embodiment.

Referring to FIG. 3, the root device 20 according to an example embodiment may verify (or identify) the root secret key and public key in operation S31.

The root secret key is the secret key associated with the root public key, and may be stored on the root device 20. The root public key may include the first identifier for the root device 20. For example, the first identifier may be the manufacturer information (for example, Samsung Electronics) for the electronic device 10 managed by the root device 20. The root public key and root secret key may be an asymmetric key pair for the highest hierarchy in the security hierarchy. For example, the root secret key may be stored in the root device 20's hardware security module (HSM), trusted platform module (TPM), or other encrypted storage.

The public key may include a first identifier for the root device 20 and a second identifier for the electronic device 10. For example, the second identifier may be the serial number of the electronic device 10, or an e-mail address of the user of the electronic device 10. For example, the root device 20 may store the public key itself or receive the public key from an external device. In another example embodiment, the root device 20 may store the individual information (for example, a first identifier and a second identifier) included in the public key itself or receive the individual information from an external device. In this case, the root device 20 may generate a public key including individual information.

In an example embodiment, the root device 20 may generate a secret key associated with the public key in operation S32.

In an example embodiment, the secret key may be generated on the root device 20 based on the root secret key and the public key. The root secret key may be a secret key associated with the root public key that includes the first identifier. The public key may include a first identifier and a second identifier. The public key and the secret key may be lower hierarchy than the root public key and the root secret key.

In an example embodiment, the root device 20 may generate a secret key associated with the public key using the root secret key and the public key according to a secret key generation algorithm. For example, the secret key of the lower hierarchy may be the result of calculating a function that takes the public key of the lower hierarchy and the root secret key of the higher hierarchy as input parameters. In another example embodiment, the secret key may be the result of a function that takes a hash function value for the public key and the root secret key as input parameters.

In an example embodiment, the electronic device 10 may store a secret key issued by the root device 20 in operation S33. For example, the root device 20 may generate a secret key associated with the public key and transmit the secret key to the electronic device 10. The electronic device 10 may store the secret key received from the root device 20 in the secure memory 12. According to an example embodiment of the present disclosure, only the root device 20 with permission to the root secret key may generate a lower-hierarchy secret key with respect to the public key. The electronic device 10, which has been injected with the secret key, may indicate that it has been authenticated by the root device 20, which is a trusted authentication entity. In this case, the electronic device 10 may use a secret key to generate a key pair that is lower hierarchy than the secret key.

In an example embodiment, the root device 20 may verify (or identify) the public key for each electronic device, and issue a secret key for each electronic device based on the public key and root secret key for each electronic device. The root device 20 may individually transmit the corresponding secret key to each electronic device. In an example embodiment, the root device 20 may inject the corresponding secret key into each electronic device via a command. For example, the command may include a vendor unique command (VUC). Each electronic device may store the secret key injected from the root device 20. The secret key stored in each electronic device may have different values.

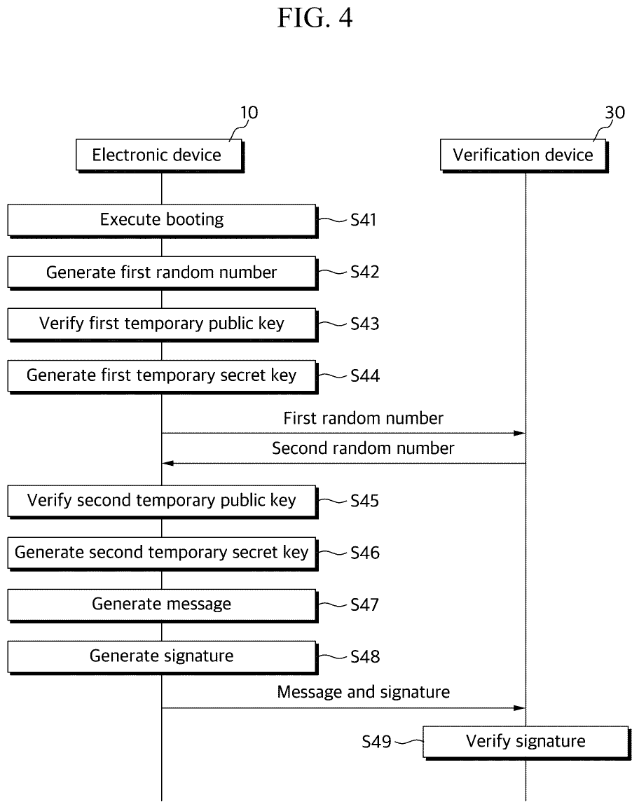

FIG. 4 is a flowchart for explaining operations of an electronic device according to an example embodiment.

Referring to FIG. 4, the operating method of the electronic device 10 according to this example embodiment may include booting in operation S41. For example, the booting may be a secure booting that verifies the integrity of the bootloader and firmware.

In an example embodiment, an operating method of the electronic device 10 may include generating a first random number in operation S42. For example, the processor 11 of the electronic device 10 may generate the first random number after booting of the electronic device 10. In another example embodiment, the processor 11 may generate the first random number if the bootloader verification and the firmware verification are passed.

In an example embodiment, the operating method of the electronic device 10 may include verifying (or identifying) a first temporary public key including a first identifier, a second identifier and a first random number in operation S43. For example, the processor 11 of the electronic device 10 may determine the first identifier, the second identifier and the first random number, and merge the first identifier, the second identifier and the first random number, for example, by forming a combined sequential code including the first identifier, the second identifier, and the random number, to generate a first temporary public key. In another example embodiment, the processor 11 of the electronic device 10 may verify (or identify) the public key, which includes the first identifier and the second identifier, and the first random number, and the processor 11 may generate a first temporary public key by merging the public key and the first random number.

In an example embodiment, the operating method of the electronic device 10 may include generating a first temporary secret key associated with the first temporary public key based on the first temporary public key and the secret key in operation S44. For example, the processor 11 of the electronic device 10 may generate a first temporary secret key using the first temporary public key and secret key according to a secret key generation algorithm. The secret key may be issued by the root device 20 and stored in the secure memory 12. The secret key may be a higher-hierarchy key relative to the first temporary public key and the first temporary secret key. The generated first temporary secret key may be temporarily stored in the processor 11 of the electronic device 10 or in a separate memory.

In an example embodiment, the operating method of the electronic device 10 may include transmitting a first random number to the verification device 30. For example, the processor 11 may send the first random number to the verification device 30. The operating method of the electronic device 10 may include receiving a second random number generated by the verification device 30. For example, the processor 11 may receive a second random number generated by the verification device 30 from the verification device 30.

In an example embodiment, the second random number may be generated by the verification device 30 in response to the transmission of the first random number. For example, the verification device 30 may generate a second random number and transmit the second random number to the electronic device 10 whenever a first random number is received. In another example embodiment, the second random number may be generated by the verification device 30 independently of the transmission of the first random number. For example, the verification device 30 may generate a second random number and transmit the second random number to the electronic device 10 whenever a certain condition is met (for example, a timeout, a reset command and so on).

In some embodiments, transmitting the first random number and receiving the second random number may be implemented differently from FIG. 4. For example, transmitting the first random number may be performed after generating the first random number in operation S42, and the order may be implemented in various other ways. The receiving the second random number may be performed before verifying (or identifying) the second temporary public key in operation S45, and the order may be implemented in various other ways.

In an example embodiment, the operating method of the electronic device 10 may include verifying (or identifying) a second temporary public key including a first identifier, a second identifier, a first random number and a second random number in operation S45. For example, the processor 11 of the electronic device 10 may verify (or identify) the first identifier, the second identifier, the first random number and the second random number, and may merge the first identifier, the second identifier, the first random number and the second random number (for example, by forming a combined sequential code including the first identifier, the second identifier, and the first random number, and the second random number) to generate a second temporary public key. In another example embodiment, the processor 11 of the electronic device 10 may verify (or identify) a first temporary public key, which includes a first identifier, a second identifier, and a first random number, and a second random number, and generate a second temporary public key by merging the first temporary public key and the second random number.

In an example embodiment, the operating method of the electronic device 10 may include generating a second temporary secret key associated with the second temporary public key based on the second temporary public key and the first temporary secret key in operation S46. For example, the processor 11 of the electronic device 10 may generate a second temporary secret key using the second temporary public key and the first temporary secret key according to a secret key generation algorithm. The first temporary secret key may be a higher-hierarchy key for the second temporary public key and the second temporary secret key. The generated second temporary secret key may be temporarily stored in the processor 11 of the electronic device 10 or in a separate memory.

In an example embodiment, the operating method of the electronic device 10 may include generating a message in operation S47. For example, the processor 11 of the electronic device 10 may receive a message request from the verification device 30. The processor 11 of the electronic device 10 may generate a message based on a received message request. The message may be response information to the message request. Receiving the message request may be performed before generating the message in operation S47, and the order may be implemented in various example embodiments.

In an example embodiment, the message may include status information on the electronic device 10. The status information on the electronic device 10 may include at least one of firmware information (for example, firmware version, firmware type, etc.), platform configuration register (PCR) information, hardware information (for example, memory model name, processor model name, temperature status, voltage status, fan speed and so on), device configuration status, and firmware hash. However, it is a mere example embodiment, and the status information on the electronic device 10 may be transformed into various information.

In an example embodiment, the operating method of the electronic device 10 may include generating a signature for a message based on a second temporary secret key in operation S48. The operating method of the electronic device 10 may include transmitting the message and the signature to the verification device 30. The processor 11 of the electronic device 10 may transmit the message and signature to the verification device 30, and the verification device 30 may receive the message and the signature. The verification device 30 may verify the signature for the message based on the second temporary public key in operation S49. For example, the processor 11 of the electronic device 10 may generate a signature using the second temporary secret key according to the signature/verification algorithms, and the verification device 30 may verify the signature using the second temporary public key according to the signature/verification algorithms.

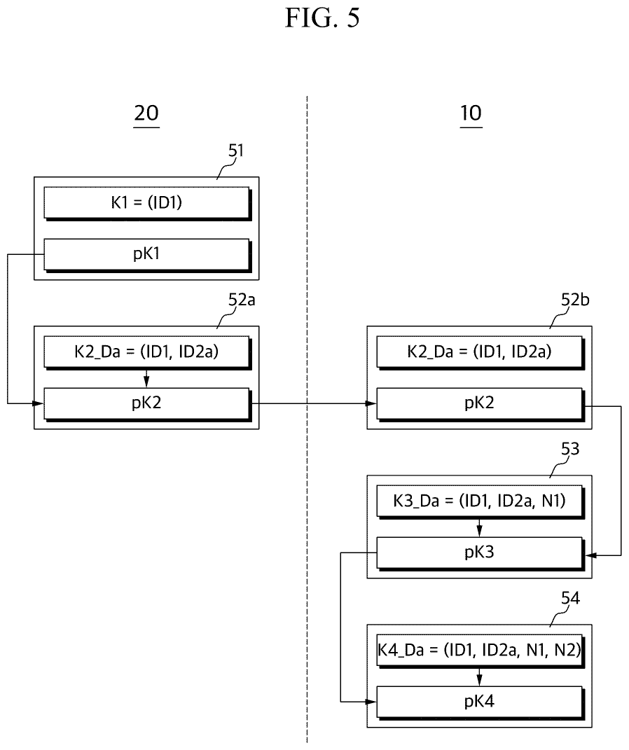

FIG. 5 is a diagram explaining key pairs of a hierarchical structure according to an example embodiment.

Referring to FIG. 5, the key pairs in the hierarchy structure may include a first hierarchy key pair 51, second hierarchy key pairs 52a and 52b, a third hierarchy key pair 53 and a fourth hierarchy key pair 54. The first hierarchy may be the highest hierarchy. The order from the first hierarchy to the second hierarchy, third hierarchy and fourth hierarchy may correspond to the order from a higher hierarchy to a lower hierarchy. Key pairs in each hierarchy may include public keys and secret keys that are related to each other.

The first hierarchy key pair 51 may include a root public key K1 and a root secret key pK1. The root public key K1 may include a first identifier ID1 for the root device 20. The root secret key pK1 may be generated by the root device 20 and managed in the root device 20.

The second hierarchy key pairs 52a and 52b may include a public key K2_Da and a secret key pK2 for the electronic device 10. The public key K2_Da may include the first identifier ID1 for the root device 20 and a second identifier ID2 for the electronic device 10. The secret key pK2 may be generated using various secret key generation algorithms such as KDF using the public key K2_Da and the root secret key pK1 of a higher hierarchy. For example, such as “pK2=KDF(pK1, K2_Da),” the secret key pK2 may be obtained by computing KDF using the public key K2_Da and the root secret key pK1 of the higher hierarchy as input parameters. The same method may be applied to lower-hierarchy secret keys. Meanwhile, the secret key pK2 may be generated in the root device 20 and injected into (e.g., stored in) the electronic device 10.

The third hierarchy key pair 53 may include a first temporary public key K3_Da and a first temporary secret key pK3. The first temporary public key K3_Da may include the first identifier ID1 for the root device 20, the second identifier ID2 for the electronic device 10 and a first random number N1. For example, the first random number N1 may be generated through a random number generator or software operations. The first temporary secret key pK3 may be generated using various secret key generation algorithms such as KDF using the first temporary public key K3_Da and the secret key pK2 of a higher hierarchy. The first temporary secret key pK3 may be generated in the electronic device 10.

The fourth hierarchy key pair 54 may include a second temporary public key K4_Da and a second temporary secret key pK4. The second temporary public key K4_Da may include the first identifier ID1 for the root device 20, the second identifier ID2 for the electronic device 10, the first random number N1 and a second random number N2. For example, the second random number N2 may be generated through a random number generator or software operation. The second temporary secret key pK4 may be generated using various secret key generation algorithms such as KDF using the second temporary public key K4_Da and the first temporary secret key pK3 of a higher hierarchy. The second temporary secret key pK4 may be generated in the electronic device 10.

For example, the secret key pK2 may be used to generate the first temporary secret key pK3, and the first temporary secret key pK3 may be used to generate the second temporary secret key pK4. The second temporary secret key pK4 may be used for the signature. After using the secret key pK2 to generate the first temporary secret key pK3, the secure memory 12 may be set to a read lock to block access to the secret key pK2. This is to prevent leakage of the secret key pK2 by minimizing the accessibility to the secret key pK2. Further, as a secret key used once or for a short period of time, the second temporary secret key pK4 may minimize exposure risk and improve security. In other words, by using the second temporary secret key pK4 based on the first random number N1 and the second random number N2 instead of the secret key pK2 for the signature, even if the second temporary secret key pK4 is exposed, a new one is generated by updating the second temporary secret key pK4. Thus, the leaked key may be useless.

By improving security at each hierarchy through key pairs in this hierarchical structure, key management efficiency may be improved. By generating a lower-hierarchy secret key based on a higher-hierarchy secret key, key management may be simplified and security may be enhanced. For example, a lower-hierarchy key pair may be generated based on the secret key pK2 with enhanced reliability in the electronic device 10, not in the root device 20. Keys in each hierarchy may be utilized for specific purposes.

In an example embodiment, the public key K2_Da, the first temporary public key K3_Da, and the second temporary public key K4_Da may be generated as tuple-type data in the order from higher hierarchy to lower hierarchy. For example, the public key K2_Da may include the first identifier ID1 and the second identifier ID2 arranged in the order of the first identifier ID1 and the second identifier ID2. The first temporary public key K3_Da may include the first identifier ID1, the second identifier ID2 and the first random number N1, arranged in the order of the first identifier ID1, the second identifier ID2 and the first random number N1. The second temporary public key K4_Da may include the first identifier ID1, the second identifier ID2, the first random number N1 and the second random number N2, which are arranged in the order of the first identifier ID1, the second identifier ID2, the first random number N1 and the second random number N2.

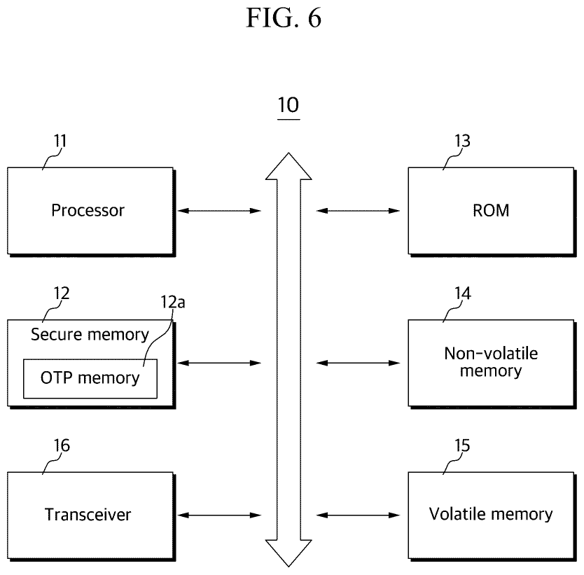

FIG. 6 is a block diagram illustrating an electronic device according to an example embodiment.

Referring to FIG. 6, the electronic device 10 according to the example embodiment may include at least one of the processor 11, the secure memory 12, a Read Only Memory (ROM) 13, a non-volatile memory 14, a volatile memory 15 and a transceiver 16. Individual components included in the electronic device 10 may be connected to each other via a bus.

The processor 11 may control and manage the overall operation of the electronic device 10.

The processor 11 may perform data processing and calculations. The processor 11 may interpret or execute programs or instructions. The processor 11 may access data stored in at least one of the secure memory 12, the ROM 13, the non-volatile memory 14 and the volatile memory 15. The processor 11 may store data in at least one of the non-volatile memory 14 and the volatile memory 15. The processor 11 may control the transceiver 16 to communicate with external devices. For example, the processor 11 may include at least one of a central processing unit (CPU), a microprocessor, an application processor, a digital signal processor (ISP), and so on.

The secure memory 12 may be responsible for storing and protecting sensitive data. In the example embodiment, the secret key issued by the root device 20 may be stored. The secure memory 12 may maintain the confidentiality and integrity of data by applying encryption technology and allows only authenticated access.

In an example embodiment, the secure memory 12 may include a one-time programmable (OTP) memory 12a. The OTP memory 12a may be a memory that may record data only once, and may be a memory in which recorded data may not be modified or deleted thereafter. The OTP memory 12a may store the secret key issued by the root device 20. According to example embodiments, security for secret keys may be enhanced with the OTP memory 12a, which is suitable for storing permanent and immutable data.

In an example embodiment, with respect to the OTP memory 12a, after a first temporary secret key is generated using the secret key, a read lock may be set on the secret key. In an example embodiment, with respect to the OTP memory 12a, the read lock may be released during the bootloader and firmware verification process during booting. For example, when the bootloader and the firmware verification is passed, the read lock may be released for the OTP memory 12a. Here, when the read lock is set, read access to the OTP memory 12a is blocked, and when the read lock is released, the OTP memory 12a may be accessible. Accordingly, by preventing unauthorized access or data leakage and ensuring that data is only accessible when necessary, security for secret keys may be strengthened.

The ROM 13 is a non-volatile memory that permanently stores data. Information stored in the ROM 13 may be maintained even if power is cut off. The ROM 13 may be a memory with restricted data writing.

The non-volatile memory 14 is memory in which stored data is maintained even when power is cut off. The non-volatile memory 14 may store various data such as user data and configuration information. The non-volatile memory 14 may be a memory in which data may be written freely compared to the ROM 13. For example, the non-volatile memory 14 may be implemented as flash memory, EEPROM and so on.

The volatile memory 15 is memory that retains data only while power is supplied. The volatile memory 15 may provide temporary data or workspace needed by the processor 11 when executing a program. The volatile memory 15 may have a faster access speed than other memories and be used to temporarily store data required for program execution, data processing, or calculations on the processor 11. For example, the volatile memory 15 may be implemented as random access memory (RAM).

The transceiver 16 is a transmitting and receiving device for the electronic device 10 to communicate with external devices or networks. The transceiver 16 may handle transmitting or receiving data. The transceiver 16 may perform communications via wired or wireless communication.

In an example embodiment, the ROM 13 may store boot code. For example, boot code is a program required to boot the electronic device 10, and may be the first thing executed when power is supplied, initializing the hardware and calling the bootloader.

In an example embodiment, the non-volatile memory 14 may store the bootloader and firmware. For example, the bootloader is executed by the boot code, and may be responsible for loading firmware (or an operating system, etc.) into the volatile memory 15. The firmware is executed by the bootloader, and may be software that controls hardware within the electronic device 10 and enables the electronic device 10 to perform specific functions. The bootloader and firmware are stored in the non-volatile memory 14 and may be updated as needed. For example, when the electronic device 100 is booted, it may be executed in the order of boot code, bootloader, and firmware. Meanwhile, in this example embodiment, the bootloader and firmware are described as being stored in the non-volatile memory 14, but the electronic device 10 may be modified and implemented such that at least one of the bootloader and firmware is stored in the ROM 13.

In an example embodiment, when power is supplied to the electronic device 10, the processor 11 may verify the bootloader by executing the boot code. When the bootloader verification is passed, the processor 11 may verify firmware by running the bootloader. When the firmware verification is passed, the processor 11 may execute the firmware. The processor 11 may generate the first random number, and generate a first temporary secret key using the first temporary public key including the first random number and secret key. As such, only when verification is passed, a first temporary secret key may be generated using the secret key.

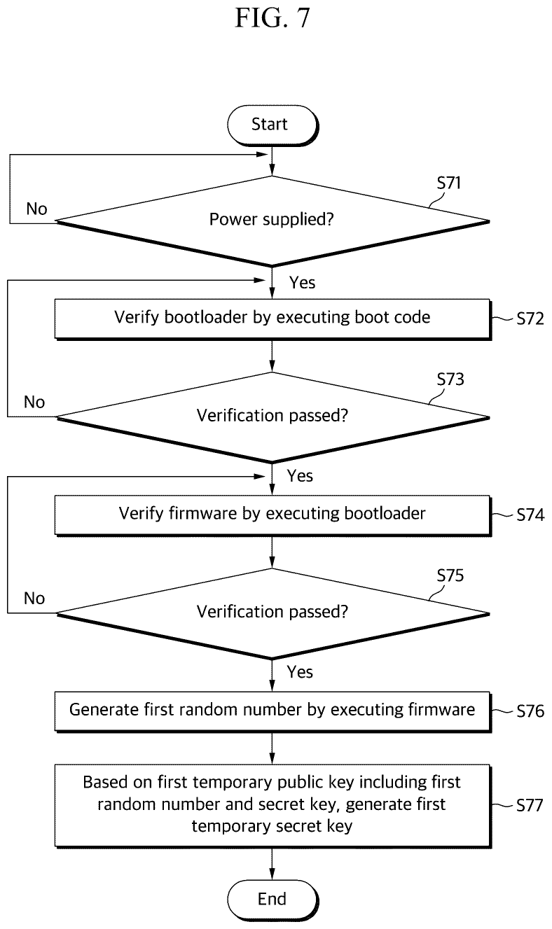

FIG. 7 is a flowchart for explaining operations of booting an electronic device according to an example embodiment.

Referring to FIG. 7, when power is supplied to the electronic device 10 in operation S71 (S71, Yes), the operating method of the electronic device 10 may include verifying the bootloader by executing the boot code in operation S72. For example, when the power is supplied to the electronic device 10, the processor 11 may verify the bootloader by executing boot code stored in the ROM 13 and verifying the digital signature or a hash value. The processor 11 may identify that the bootloader verification is passed when the verification result shows that the bootloader has not been tampered with.

When the bootloader verification is passed in operation S73 (S73, Yes), the operating method of the electronic device 10 may include verifying firmware by executing the bootloader in operation S74. For example, when the bootloader verification is passed, the processor 11 may verify firmware by running a verified bootloader and verifying the digital signature or the hash value of the firmware. The processor 11 may identify that the firmware verification is passed when the firmware has not been tampered with as a result of the verification.

When the firmware verification is passed in operation S75 (S75, Yes), the operating method of the electronic device 10 may include generating a first random number by executing the firmware in operation S76. For example, the processor 11 may generate the first random number using a random number generation algorithm by running verified firmware. In another example embodiment, when the firmware verification is passed in operation S75 (S75, Yes), a random number generation circuit included in the electronic device 10 may generate a first random number.

In operation S77, the operating method of the electronic device 10 may include generating a first temporary secret key using the first temporary public key including the first random number and secret key. The first temporary public key may further include a first identifier for the root device 20 and a second identifier for the electronic device 10.

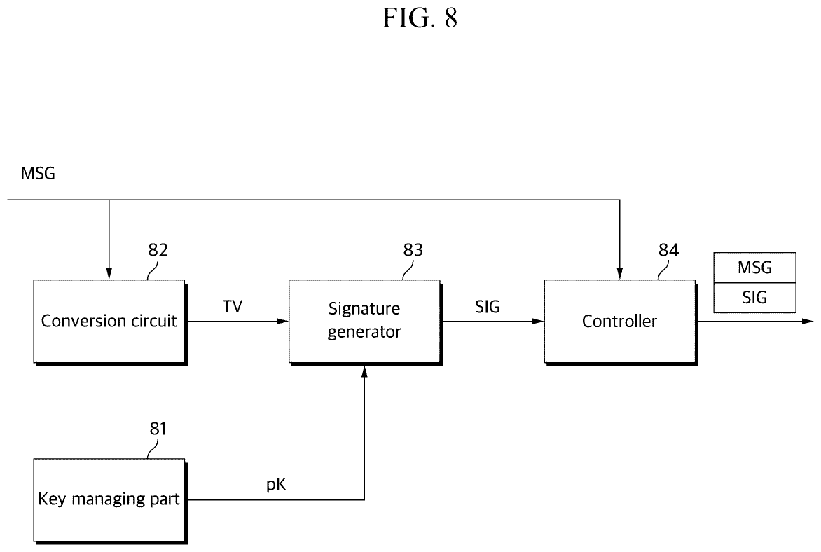

FIG. 8 is a drawing for explaining a system for signature generation according to an example embodiment.

Referring to FIG. 8, the system for generating a signature according to an example embodiment may include a key managing part 81, a conversion circuit 82, a signature generator 83 and a controller 84. For example, a system for generating a signature may be included in the electronic device 10 or the processor 11.

The key managing part 81 (e.g., which may include hardware, firmware, and/or software) may be responsible for the generation and management of a signature secret key pK used in a signature SIG. For example, the signature secret key pK used in the signature SIG may include the second temporary secret key mentioned above.

The conversion circuit 82 may generate a transformation value TV by inputting an input message MSG into the conversion function. For example, the conversion function may be a variety of functions to reduce the size of the message MSG and enhance security, such as a hash function or encoding function. The transformation value TV may be a converted value of the message MSG, such as a hash value and a summary value. For example, in the case of a hash function, the message MSG with arbitrary length (or size) may be converted into a hash value with fixed length (or size). For example, such as “TV=H(MSG),” the conversion circuit 82 may input the message MSG into a hash function to generate the transformation value TV. In the embodiments, the transformation value TV may be referred to as the conversion value.

The signature generator 83 may generate the signature SIG using the transformation value TV and the signature secret key pK. For example, the signature generator 83 may generate the signature SIG using the transformation value TV and the signature secret key pK through an algorithm such as RSA and ECDSA. For example, such as “SIG=Sign(TV, pK),” the signature generator 83 may generate the signature SIG by inputting the transformation value TV and the signature secret key pK into the signature generation function.

The controller 84 may manage the message MSG and the signature SIG. The controller 84 may transmit the message MSG and the signature SIG together to the system for signature verification. Here, the message MSG may indicate the original data being transmitted. The signature SIG may refer to a value obtained by signing the transformation value TV for the message MSG using the signature secret key pK. For example, the signature SIG is generated by applying the signature secret key pK to the transformation value TV derived from the message MSG, ensuring the authenticity and integrity of the message MSG.

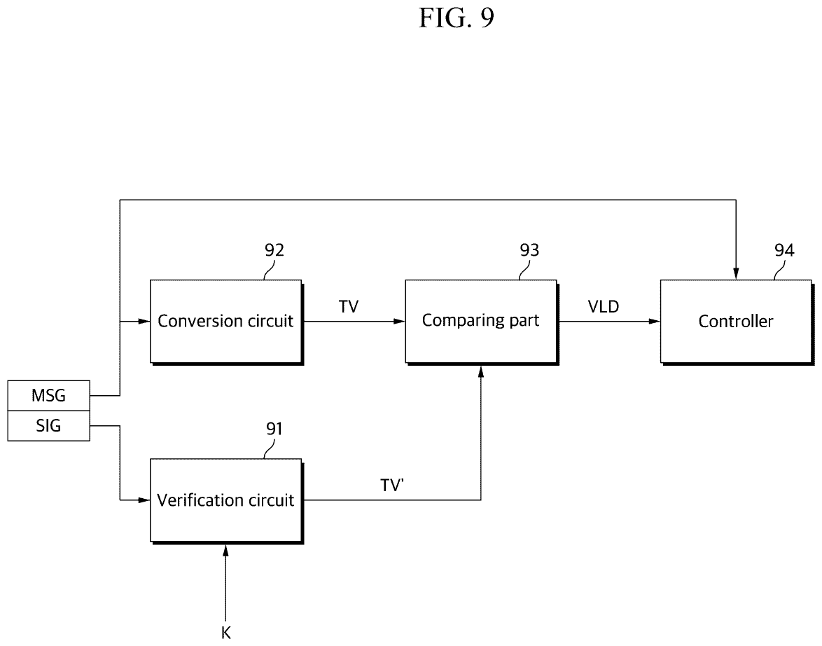

FIG. 9 is a diagram illustrating a system for signature verification according to an example embodiment.

Referring to FIG. 9, the system for signature verification according to an example embodiment may include a verification circuit 91, a conversion circuit 92, a comparing part 93 and a controller 94. For example, the system for signature verification may be included in the verification device 30. The system for signature verification may receive the message MSG and the signature SIG from the system regarding signature generation.

The verification circuit 91 may verify the received signature SIG using public key K to generate a transformation value TV'. Here, the public key K is the key associated with the signature secret key pK used when generating the signature SIG, and may be a second temporary public key. For example, the verification circuit 91 may generate the transformation value TV′ using the signature SIG and public key K through algorithms such as RSA and ECDSA. For example, such as “TV′=Verify(SIG, K),” the verification circuit 91 may recover the transformation value TV′ by inputting the signature SIG into the verification function with the public key K.

The conversion circuit 92 may input the received message MSG into the conversion function to generate the transformation value TV. The conversion circuit 92 may use the same conversion function (for example, hash function, encoding function, and so on) as the conversion circuit 82 of the system for signature generation. For example, such as “TV=H(MSG),” the conversion circuit 92 may input the received message MSG into a hash function to generate the transformation value TV.

The comparing part 93 (e.g., comparing circuit) may verify the validity of the signature SIG by comparing the transformation value TV′ generated in the verification circuit 91 and the transformation value TV generated in the conversion circuit 92. For example, when the transformation value TV′ of the verification circuit 91 and the transformation value TV of the conversion circuit 92 are the same, the comparing part 93 may output validity information VLD with a first value indicating that the signature SIG is valid. When the transformation value TV′ of the verification circuit 91 and the transformation value TV of the conversion circuit 92 are not the same, the comparing part 93 may output the validity information VLD with a second value indicating that the signature SIG is invalid.

The controller 94 may identify whether the received message MSG has been tampered with according to the validity information VLD of the comparing part 93. For example, when the validity information VLD with the first value is received, the controller 94 may identify that the message MSG has not been tampered with, and when the validity information VLD with a second value is received, the controller 94 may identify that the message MSG has been tampered with. The fact that the message MSG has not been tampered with may indicate that the message MSG was generated by the system for signature generation and transmitted as is.

According to example embodiments described above, an electronic device 10 is provided for which the security is improved, an electronic system 1 including the electronic device 10 having improved security is provided, and an operating method of the electronic device 10 is provided. According to example embodiments, it is possible to prevent falsification of information even if a previously used secret key is stolen or exposed. According to example embodiments, it is possible to pass verification only when a key based on a random number generated by a verification device is used when the verification is performed. According to example embodiments, it is possible to generate a trusted secret key since access to the secret key is possible only when the secure booting is performed normally. According to example embodiments, it is possible for an electronic device to generate its own trusted secret key. According to example embodiments, it is possible to simplify the attestation process by using a public key that replaces an authentication certificate and increase attestation efficiency.

The electronic device 10, the root device 20 and the verification device 30 according to the above-described example embodiments may include a processor, a memory for storing and executing program data, a permanent storage such as a disk drive, and/or a user interface device such as a communication port, a touch panel, a key and/or a button that communicates with an external device. Methods implemented as software modules or algorithms may be stored in a computer-readable recording medium as computer-readable codes or program instructions executable on the processor. Here, the computer-readable recording medium includes a tangible, non-transitory medium such as a magnetic storage medium (for example, ROMs, RAMs, floppy disks and hard disks) and an optically readable medium (for example, CD-ROMs and DVDs). The computer-readable recording medium may be distributed among network-connected computer systems, so that the computer-readable codes may be stored and executed in a distributed manner. The medium may be readable by a computer, stored in a memory, and executed on a processer.

The example embodiments may be represented by functional block elements and various processing steps. The functional blocks may be implemented in any number of hardware and/or software configurations that perform specific functions. For example, an example embodiment may adopt integrated circuit configurations, such as memory, processing, logic and/or look-up table, that may execute various functions by the control of one or more microprocessors or other control devices. Similar to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means” and “configuration” may be used broadly and are not limited to mechanical and physical elements. The terms may include the meaning of a series of routines of software in association with a processor or the like.

The above-described example embodiments are merely examples, and other embodiments may be implemented within the scope of the claims described below.

What is claimed is:

1. An electronic device comprising:
a secure memory configured to store a secret key issued by a root device; and
a processor configured to generate a first temporary secret key associated with a first temporary public key based on the first temporary public key and the secret key,
wherein the first temporary public key comprises a first identifier for the root device, a second identifier for the electronic device, and a first random number.

2. The electronic device of claim 1, wherein the processor is configured to:
identify a second random number generated by a verification device; and
generate a second temporary secret key associated with a second temporary public key based on the second temporary public key and the first temporary secret key,
wherein the second temporary public key comprises the first identifier, the second identifier, the first random number and the second random number.

3. The electronic device of claim 2, wherein the processor is configured to:
generate a signature for a message based on the second temporary secret key; and
transmit the message and the signature to the verification device.

4. The electronic device of claim 3, wherein the processor is configured to transmit the first random number to the verification device.

5. The electronic device of claim 4, wherein the second random number is a number generated by the verification device in response to transmission of the first random number.

6. The electronic device of claim 3, wherein the message comprises status information about the electronic device.

7. The electronic device of claim 1, wherein the secure memory comprises a one-time programmable (OTP) memory configured to store the secret key and set a read lock for the secret key after the first temporary secret key is generated.

8. The electronic device of claim 1, wherein the secret key is a key generated by the root device based on a public key and a root secret key associated with a root public key,
wherein the root public key comprises the first identifier, and
wherein the public key comprises the first identifier and the second identifier.

9. The electronic device of claim 1, further comprising:
a read-only memory (ROM) configured to store a boot code; and
a non-volatile memory configured to store a bootloader and firmware,
wherein the processor is configured to:
based on power being supplied to the electronic device, verify the bootloader by executing the boot code;
based on verification of the bootloader being passed, verify the firmware by executing the bootloader; and
based on verification of the firmware being passed, generate the first random number by executing the firmware.

10. The electronic device of claim 1, wherein the first temporary public key comprises the first identifier, the second identifier and the first random number in a tuple format according to an order that is from a higher hierarchy to a lower hierarchy.

11. An operating method of an electronic device, the operating method comprising:
storing a secret key issued by a root device in a secure memory of the electronic device; and
generating a first temporary secret key associated with a first temporary public key based on the first temporary public key and the secret key,
wherein the first temporary public key comprises a first identifier for the root device, a second identifier for the electronic device and a first random number.

12. The operating method of the electronic device of claim 11, the method further comprising:
transmitting the first random number to a verification device;
receiving a second random number generated by the verification device; and
generating a second temporary secret key associated with a second temporary public key based on the second temporary public key and the first temporary secret key
wherein the second temporary public key comprises the first identifier, the second identifier, the first random number and the second random number.

13. The operating method of the electronic device of claim 12, the method further comprising:
generating a signature for a message based on the second temporary secret key; and
transmitting the message and the signature to the verification device.

14. The operating method of the electronic device of claim 13, wherein the message comprises status information on the electronic device.

15. The operating method of the electronic device of claim 12, wherein the second random number is generated by the verification device in response to transmission of the first random number.

16. The operating method of the electronic device of claim 11, wherein the secure memory comprises an OTP memory configured to store the secret key.

17. The operating method of the electronic device of claim 11, wherein the electronic device further comprises a ROM configured to store a boot code and a non-volatile memory configured to store a bootloader and firmware, and
the operating method of the electronic device further includes:
based on power being supplied to the electronic device, verifying the bootloader by executing the boot code;
based on verification of the bootloader being passed, verifying the firmware by executing the bootloader; and
based on verification of the firmware being passed, generating the first random number by executing the firmware.

18. The operating method of the electronic device of claim 11, wherein the secret key is generated by the root device based on a root secret key associated with a root public key and a public key,
wherein the root public key comprises the first identifier, and
wherein the public key comprises the first identifier and the second identifier.

19. An electronic system comprising:
an electronic device configured to:
store a secret key issued by a root device;
generate a first temporary secret key associated with a first temporary public key based on the first temporary public key comprising a first identifier for the root device, a second identifier for the electronic device, and a first random number, and based on the secret key;
generate a second temporary secret key associated with a second temporary public key based on the second temporary public key comprising the first identifier, the second identifier, the first random number, and a second random number received from a verification device, and based on the first temporary secret key; and
generate a signature for a message based on the second temporary secret key; and
a verification device configured to verify the signature based on the second temporary public key when the message and the signature are received from the electronic device.

20. The electronic system of claim 19 wherein the secret key is generated by the root device based on a root secret key associated with a root public key and a public key,
wherein the root public key comprises the first identifier, and
wherein the public key comprises the first identifier and the second identifier.
